(19) United States
(12) Patent Application Publication
(10) Pub. No.: US 2008/0116829 A1
(43) Pub. Date: May 22, 2008

(54) Efficient AC circuit for motor with like number of poles and magnets

(76) Inventor: Sten R. Gerfast, (US)

Correspondence Address: STEN R. GERFAST, 1802 VALLEY CURVE, MENDOTA HEIGHTS, MN, 55118, US

(21) Appl. No.: 11/599,844

(22) Filed: Nov. 16, 2006

(51) Int. Cl. H02P 6/08; H02P 1/04; H02P 6/14

(52) U.S. Cl. 318/400.11; 318/400.17; 318/400.26; 318/400.13

(57) ABSTRACT

Simple AC circuitry driving a brush-less motor having a rotor consisting of alternate polarity permanent magnets poles, with the rotor journaled in a stator with a like number of wound poles having only two free ends for energizing. The motor is using only two AC electronic switches for starting and accelerating, and an AC switch to run the motor at synchronous speed. It has higher efficiency than previously known circuits, uses less parts and is less costly.

### TECHNICAL FIELD.

This invention relates generally to AC circuitry for brush-less motors with permanent magnet rotors, using only two electronic switches for starting and an AC switch to run. It is more efficient than previously known circuits. In addition it is also simpler and less expensive than known art. It can be used for a brushless motor with like number of poles and permanent magnet poles. More specifically its RPM is related to AC line frequency.

### BACKGROUND

Many different circuits for brushless motors have been invented to efficiently run these motors. Permanent magnet brushless electric motors are desirable for efficiency. These motors efficiency are greater than induction motors because of the losses in the “induction process”. A typical efficiency of an induction motor is in the range of 25 to 60%, whereas a permanent magnet brushless motor can have efficiencies up to 90%.

A more common efficiency of a permanent magnet brushless motor is in the 60% to 80% if a low cost ferrite magnet material is used. To achieve higher efficiencies a more expensive magnet material such as neodymium-iron-boron, alnico, samarium-cobalt can be used, but their higher cost makes it prohibitive for usage in simple appliance or fan motor applications. All electric motors are generating torque between a stator and a rotor. Since brushless motors have its rotor's magnetic flux supplied with permanent magnets, it is not necessary to have this magnetic flux supplied with a wound field, or windings. This makes the brushless type also inherently more efficient.

All today's permanent magnet brushless motors are driven with direct current (DC). A brushless motor is generally more expensive then an induction motor because it needs an electronic circuit board to switch DC pulses to the motor windings on the stator at the appropriate time. The Department of Energy is mandating higher efficiencies on appliances in the future, which means that appliance motor manufacturers will be forced to make more efficient motors in the future. An appliance with a higher efficiency motor, having a higher initial cost then an induction motor, still could have a short time payback, especially if the application of the motor is where the motor runs for many hours of the day, in an area where the cost of electricity is high. Most brushless motors manufactured today uses a special stator and rotor construction and an electronic circuit that is called a three phase drive, which makes the rotor, stator & circuit more complex and therefore also more expensive.

The three-phase drive circuit has many parts and therefore more expensive to manufacture, and it is using either six or 12 electronic switches to commutate the DC to the motor. Three-phase motors manufactured today typically have a different number of stator poles versus rotor poles; including different pairings of stator versus rotor poles. One term of these pairings are divisible by three, such as 6-8, 12-8, 4-6, 6-2, that makes it possible to switch, or commutate, the different coils in a tree-phase fashion.

Brushless tree-phase motors are using direct current that is switched by electronic switches and then flows sequentially through two of the three phases at any one time. One phase is not energized at the same instant. Some manufacturers use this “idling” phase to extract speed information. Therefore a 3-phase motor with two coils (or coil sets) energized at the time, only utilizes approximately two thirds, or 66%, of the (copper) windings at any one time. The permanent magnet poles on the rotor in front of these two coils are repelled or attracted to rotate the rotor, utilizing only the magnetic flux that is directly in front of these two energized coils, or approximately 66% of the magnet flux that are available.

This type of 3-phase motor is using three rotation sensors, to sense the correct rotor position, and then “signal to switch” either six or 12 electronic switches (transistors). The switching is done from a direct current source, or a rectified AC supply module with DC output. Supply modules require large filter capacitors. The DC is switched to the appropriate coil windings on the poles, in sequence.

The term “electronic switches”, used above, normally are DC type switches that include: transistors, field effect transistors, mos-fets (metal oxide semi-conductor field effect transistors), or gbt (gated bi-polar transistor). These switches are producing square wave DC output pulses to the coils. A square wave is causing less heating effect in the above listed semi conductors, and that is also the main reason that square wave switching is used. But square wave switching also causes a quite severe EMI (Electro-magnetic-interference) that makes it necessary to use many (quite expensive) EMI filter components. If the direct current would be switched as a modified “rounded corner” sine wave, the heating effect, if used continuously, could destroy the semi conductors.

Square wave switching is also causing the rotor to have a “cogging” effect, or non-uniform rotation, that is causing noise and resonance frequencies. Some related art motors are applying resonance damping components to minimize this noise and resonance. The above un-desirable difficulties and irregularities, and the correcting measures, makes the state of the art brushless motor very complex, with its cost high enough to limit its use to only less cost sensitive applications.

A lot of energy could be saved if more brushless motors were in use. A less costly permanent magnet motor would have a greater acceptance, and greater sales, then the currently available motors. With today's emphasis on conservation of our energy resources, and our striving to increase efficiencies, it is timely to modify our electric motors for greater efficiency without incurring an increase in cost.

### SUMMARY OF THE INVENTION.

The motor of the present invention is increasing efficiency of a brushless motor and substantially reducing the cost of its circuitry. The total cost of this motor and circuit is estimated to be above the cost of an induction motor (that uses no circuit) and well below the cost of a state of related art brushless motors. Another object of this invention is to use un-rectified AC, or sine-wave type start pulses and AC run for less EMI, smoother torque and less resonance frequencies. It also eliminates a separate DC supply or rectifier module. This invention relates generally to circuits for brushless electric motors having a rotor with attached permanent magnets, with alternating North and South magnet poles. This rotor is rotatably journaled in a stator frame, having winding slots between salient poles. Salient poles can have windings around one protruding pole or have windings around multiple salient poles, that is known in the industry as distributed windings. The winding in the slots is wound with magnet wire forming a specific number of wound poles, with a like number of poles as the above mentioned permanent magnet poles. The salient poles are wound with coils alternating in winding direction to produce North and South electromagnet poles. These alternately wound coils are coupled to form a single coil with two free ends.

With only two coil-ends to energize, it is possible to use only two electronic switches to alternate the polarity of all the salient pole windings at any one time, a definite cost advantage. A related art 3-phase motor have at least 3 coils connected in a star or delta connection with at least 3 free ends.

Contrary to the above-mentioned related art motors this invention is using all the coils or 100 percent of the magnet wire (copper) windings at any one time. With the North and South electro-magnet poles directly in front of the same number of North and South permanent magnet poles, at any one time, where the available magnetic flux is also about 100 percent. The electronic switches can be mosfets, transistors, igbt's, scr's or triac's. The increased utilization of both the windings and the magnetic flux is one of the advantages and the increased efficiency of the present invention. Another advantage is the decreased number of electronic switches and the simple inexpensive circuit with less components and its lower parts cost as well as its lower assembly cost.

The term “electronic switches”, as mentioned above, can include: transistors, field effect transistors mos-fets (metal oxide semi-conductor field effect transistors), or igbt (gated bi-polar transistor). The present invention can use the transistors named above as electronic switches, but since an AC switching is used, in addition, the switch types belonging in the thyristor-family like scr, triac (ac switch with three terminals) can also be used; with the scr (silicon controlled rectifier), triac and mosfet being the most cost-effective.

Thyristors are designed to be used on AC without the above mentioned heating effect. Semiconductor manufacturers have been using an array of confusing terms for the three terminals of these devises: Anode, cathode, collector, emitter, M1, M2, gate, base, drain, source. For simplicity this application will using input terminal, output terminal and gate. For starting purposes mosfets can be used without much heating effect, since they are used only momentarily. The circuit also uses diodes in addition to the scr's or mosfets. Mosfets contain intrinsic diodes that can substitute for the mentioned diodes. The incoming current to the two switches, or mosfets if used, is regular AC as it appears on regular AC outlets. One of the two switches are connecting “positive half-phases” to the alternately wound coils and the other switch is connecting “negative half-phases” to the same coils a fraction of a second later. With 60 hertz AC used, this time difference would be 8.3 mill-seconds.

During acceleration of the motor rotor, a plurality of positive and negative half-phases is occurring in acceleration-phase A (see FIG. 2) goes through acceleration-phase B and further accelerates when the current increases in the stator windings, until one positive and one negative half-phase is becoming a re-constituted full wave, (acceleration-phase C). During acceleration back-EMF is also occurring in the winding shown as a distorted wave in B. Winding inductance, resistance and load can alter the wave shape. When the motor is running on a re-constituted full wave, (C) the rotor runs in synchronism with the line frequency. Synchronism is defined as one magnetic pole moving from one stator pole to adjacent stator pole in the time period of one half-phase of said energizing sine wave or AC. At synchronism a switch-in to replace the re-constituted full-wave with “regular” AC is taking place. After switch-in the motor runs continuously on this regular AC. This is shown in ( D), FIG. 2.

The alternately wound coils, with two free ends, can also have a secondary winding wound adjacent to it, or at an angle mechanically displaced from the main coils from 1 degree to 45 degrees that could aid in the synchronizing phase. A small capacitor can be connected across or in series with the either winding, similar to an AC “split phase”, an AC capacitor motor, or “permanent split phase” (PSC) motor without deviating from the basic premise of the present invention, which is, that two free ends of stator coils are connected by two switches feeding sine wave half-phases into said two free ends until a re-constituted full wave runs the motor rotor and produces torque. And following synchronism the reconstituted full-wave is being “shunted” with regular AC into the two free ends.

Depending on the motor application the extra winding and capacitor are not necessary for the motor of the present invention to run correctly, and can in most applications be eliminated. If an extra winding is used to increase starting torque or run performance it is generally designed for a specific phasor diagran, or phase angle displacement diagram,. One possible such diagram is shown in FIG. 6.

The motor windings are designed for the lowest power draw during run, for the voltage specifications of the motor-customer and to have the best start and run for the specific motor usage. The lowest power input can also be monitored and optimized by a micro-controller, even after a temporary larger power input to accelerate the motors load. Contrary to related art 3-phase motors (run on DC and measured in DC watts; or having a rectifier module operated from AC, measured in AC watts), the motor of the present invention, running on AC, has its input power measured in input AC watts. Output of any motor is measured in watts: oz-inches of torque×RPM×0.00074=watts out. Or measured with similar formulas (One horse-power equals 746 watts) Efficiency is calculated by dividing output watts over input watts. The phase angle of the winding is determined by number of turns/magnet wire gauge (impedance, resistance and capacitance) and if a start winding or capacitor is used, the phase angle is then determined by all four parameters..

Summarizing: at start the two switches apply power to the two free ends of the single coil winding (or start winding in parallel, if used) alternately, with one switch supplying the positive half-phases of the incoming sine wave (derived from AC) and the other switch supplying the negative half-phases of the incoming sine wave causing the magnetic rotor to advance one magnetic pole phase per half-phase.

During start-up and acceleration multiple sine wave half-phases, of the same polarity, are used for the advance of one magnetic pole, but at steady speed one positive half-phase and one negative half-phase equals an approximate, or re-constituted, sine wave, and the motor is running on this re-constituted AC. At synchronism with the line frequency a regular AC is switched-in shunting the re-constituted AC. This switch-in can be done with a third switch such as a triac driven by the diminishing current at synchronism, a mechanical switch or relay. The rotors angular mechanical position, or rotation, is measured by a rotor position sensor that then sends commands to the appropriate switch to turn on the appropriate half-phase. This sequence continues until the rotor is up to speed, meaning in synchronism with the AC frequency. In USA, and some other countries, the line frequency is 60 hertz that would make a motor with six stator poles turn a six pole magnetic rotor to run at 1200 RPM. Similarly a 10 pole motor is running 720 RPM, 8 pole=900 RPM, 4 pole=1800 RPM, 2 pole=3600 RPM. In countries that are using 50 Hertz the synchronous RPM would be ⅚^{th} of the above RPM. During start/run, the motor runs with a smooth sine-wave with only minor switching transitions on the sine-shape. After switch-in the motor runs with a totally smooth regular AC.

After synchronous speed has been reached the current in the windings are decreasing. This current decrease is used through an inverter transistor to turn on a triac (a third switch) to do a switch-in of regular AC into the two free ends of the coils. At that time the motor continues to run at synchronous speed on that regular AC (or household outlet AC) and the re-constituted full-wave is by-passed. The “switch-in” can also be made with a mechanical centrifugal switch or a relay. The rotors running direction is switchable from clockwise to counterclockwise by positioning a rotation sensor either side of the neutral axis between said wound poles or by transposing said free ends. This invention could be described as an AC motor drive circuit for a brushless motor comprising:

a rotor with permanent magnet poles journaled in a stator having a like number of poles,
each comprising alternately wound coils coupled to form a single coil with two free ends,
said two free ends alternately energized with sine wave pulses to start and accelerate said rotor into synchronism with said sine wave, following said synchronism a switch connects said two free ends to AC. Or it could be described as an AC motor drive circuit for a brushless motor comprising:

a rotor with a number of alternate polarity permanent magnets,

said rotor having a central shaft rotatably journaled in a stator having a like number of alternately wound coils coupled to form a single coil with two free ends,

said two free ends alternately energized with positive half-phases and negative half-phases of an alternating sine wave, wherein said energizing produces starting and acceleration-torque for the rotation of said rotor, following said rotors acceleration into synchronism with said sine wave, a switch connects said two free ends to AC. The invention is characterized by the fact that said two free ends are the sole electrical connection to said stator, even if a secondary winding might be connected in parallel. It is further characterized by the fact that it has like number of permanent magnet poles and like number of wound stator poles. Synchronism is defined as one magnetic pole moving from one stator pole to adjacent stator pole in the time period of one half-phase of said energizing sine wave or AC. This invention could also be described as an AC motor drive circuit for a brushless motor comprising:

a rotor with a number of alternate polarity permanent magnets rotatably journaled in the motor a stator having a like number of alternately wound coils coupled to form a single coil with two free ends, said two free ends alternately energized with positive half-phases

and negative half-phases of an alternating sine wave,

a rotor position sensor sending signals for controlling the timing of said alternate energizing, said signals connected to two electronic switches and at least two diodes to achieve said alternate energizing that magnetically produces starting and acceleration-torque for the rotation of said rotor,

following said rotors acceleration into synchronism with said sine wave,

a switch connects said two free ends to AC, The present invention is utilizing the very high torque produced when a permanent magnet rotor is driven by a continuous AC sine wave, which also gives this motor its high efficiency.

Since all engineering designs are compromises: if this motor became overloaded it would drop out of synchronous speed and run at about half-speed. Another compromise it that it is sensitive to inertia loads. Either of these conditions can be sensed by a micro-processor, and in turn, it would correct the above conditions by an increase in input voltage/current to alleviate these conditions. The same micro-controller can also change the input power to the two free ends to achieve the lowest input power to securely drive the load and at the same time optimize the efficiency. An AC sine wave shape can also be approximately re-formed from a DC source in a local circuit board with the capability of varying the outputs AC frequency, if the customers so desired. In the motor of the present invention energizing with this varying frequency would of course also vary the motors RPM.

This motors “energizing”, and running is preferably done with AC from an AC outlet with the rotors RPM directly related to the alternating current's frequency at the outlet. Motors running on line AC is also the less costly power source available; no rectifier or capacitors required.

The rotor is following the alternating “waves” uniformly, that produces a uniform and smooth rotational torque in contrast with the related art “square wave pulses” of direct current that gives torque pulsations with each square wave “onset”. Torque pulsations, or cogging, also generates noise that has to be counteracted in presently manufactured related art motors. The square wave pulses in related art 3-phase machines, switched at rotor frequency, or at PWM frequency, (pulse width modulation) are also generating fairly severe electronic modulation interference (EMI) that has to be counteracted with expensive EMI filters and components, for it to be below EMI regulation limit. . This brings another advantage of the present invention that requires no or minimal EMI components. Instead of using three rotor position sensors in related art 3-phase motors, the present invention uses only one position sensor; a definite cost advantage. This single output sensor can be augmented with an inverting transistor. The sensor can be a magnetic sensor, an optical sensor or tachometer, all indicating what polarity of the permanent magnet on the rotor is, that is presently in front of the sensor. The sensor is generally positioned off-axis between poles to favor a rotation direction. We can use a magnetic sensor, also known as a Hall IC (integrated circuit) having either one or two outputs. A two output sensor is shown FIG. 1. A Hall sensor requires only 20 milliamp of DC. (that could be supplied from a small rectifier connected to the AC line). A small smoothing capacitor smoothens the rectified current to the Hall IC. When a Hall IC has only a single output an inverter transistor achieves the second output. When a Hall IC has a positive output, a following inverter inverts that signal to a negative output. The inverting transistor augments a one output Hall IC into positive/negative dual drive signals to the switches. When the Hall IC is High (+) the inverter signal is Low . . . and vice versa. If the sensor ceased to sense rotation, indicating a locked rotor, it would inhibit further drive signals, and thereby providing locked rotor protection. Describing the switching action in a six pole motor (other pole-structures are similar) of the present invention: if the rotor magnet in front of the sensor is a South pole the Hall sensor's “Plus” voltage turns on the switch supplying positive half-phases to the North pole coil on the stator that attracts the South pole on the rotor, causing the rotor to move into alignment with the North stator coil. At the same instant the inverter is Low turning off the negative half-phases. Of course there are three magnetic South poles on the rotor that are being attracted by three North stator coil, and at the same instant, three magnetic North poles on the rotor being attracted by three South stator coils. This means that all six magnets are attracted by six stator coils as long as the positive half-phases are on. This also means that all the available magnetic flux is used . . . and 100% of the copper windings on all stator coils (wound alternately North/South) are used as long as the Hall+turns on positive half-phases. When the rotor “moves into alignment”; (a 60 degree step) the Hall sensor goes Low and the inverter goes High, with the inverter supplying positive voltage to the switch supplying negative half-phases to all the six stator coils causing the rotors six magnets to be attracted by all six stator coils and the rotor turns one step, or 60 degrees. This repeats, and the rotor accelerates until only one positive half-phase and one negative half-phase are driving the coils, with one positive half-phase and one negative half-phase phase equaling a sine wave shown in FIG. 2 (C). After switch-in it is a perfect sine wave FIG. 2 (D) The two diodes shown FIG. 1 are assuring the correct polarity at all times. If mosfet switches are used the internal intrinsic diodes that are part of basically all mosfets serves as two above diodes. This sine wave is producing torque on the rotor with very good efficiency. The final switch-in of AC to the two free ends makes the motor run on regular AC, sometimes referred to as household current or power line voltage, that can be 120, 240 or other higher voltages All rotation sensors that are manufactured today have to be supplied with low voltage DC to function. If the application of this invention is for a high voltage motor such as 120 or 240 volts AC, it needs to have a voltage dropping resistor and a rectifier for the DC supply (as mentioned above) that are to be used for the position sensor. In addition a de-coupling capacitor is generally used to smoothen the rectified DC.

As a replacement for the rotation position sensor it is possible to use a so called “sensor-less” timing signals to the electronic switches. Replacement generally requires the inclusion of a micro-controller to sense induced Back-EMF (electromagnetic flux) in any coil in the stator and then generate timing signals from the Back-EMF to drive the two switches. Since Back-EMF is only generated when the rotor is in motion, the micro-controller would, as a start function, send out an initial start signal and then continue to send timing signals If the circuit warrants the extra cost of the micro-controller, additional motor features can be performed by programming the controller. These added features, like voltage/current control, would then be possible without much added cost. With or without the controller this simple inexpensive circuit in conjunction with the simple motor construction is a more efficient, inexpensive motor, then present brushless motors available today.

A photo-coupler that isolates the low voltage from the high voltage can be incorporated. Photo-couplers are available with scr, transistor or other output designs. They are also available with ZCS (Zero-crossing-switching at AC null point); a definite advantage for less EMI, and a smoother AC sine wave. Zero-crossing-switching at AC null point is also preferred for the “switch-in” function. The illustrations and specifications are by no means conclusive; alternate design are quite possible. A person skilled in the art can make alterations of the illustrated schematic provided, without altering the scope.

Summation of the present invention:

Advantages:

Windings coupled together into single coil with two free ends, requiring only two AC rated electronic switches.

These two switches supply AC positive/ negative half-phases to windings, becoming re-constituted full-wave AC.

After synchronizing a switch connects the windings to regular AC and motor runs on AC.

Uses about 100% of both the windings and the magnetic flux, with like number of poles, for better efficiency.

Runs on AC, no need for rectified DC motor supply, no large capacitors, with its inherent rectification power losse

Drive circuit using AC is smoother with less EMI; no or less EMI parts, less cogging noise and less resonance.

Uses only one rotor position sensor or sensor-less operation.

Simpler, energy-saving, cost-effective motor with less expensive mechanical and drive components.

Dis-advantages:

Limited in rotational speed related to AC frequency and number of pole-structures.

Sensitive to overload and inertia.

The above short-comings can also be overcome by a flexible coupling having cup-shaped circular plate attached to the rotor shaft and a secondary cup-shaped circular plate co-axially journaled with the first, with the secondary plate serving as an output plate, a spring member attached to said shaft engaging slots in both said plates, giving torsional flexibility between both said plates and said shaft, and a void between the two plates being filled with viscous material or gel. Another option would be to have magnetic co-action or coupling between the two plates. The secondary plate is to be connected to the load. See FIG. 5. Assuming that sometimes there is too high a load for the rotor to synchronize, the original slippage between the two plates is allowing a gradual acceleration of the load to get synchronism. The stated illustrations, circuit and the mechanical specifications are by no means conclusive; alternate design is quite possible. A person skilled in the art can make alterations of the specification without altering the scope of the invention.

### BRIEF DESCRIPTION OF THE DRAWINGS.

FIG. 1 is a schematic of the AC drive circuit showing components, AC input terminals and the coils two free ends.

FIG. 2 is showing acceleration sequences A, B, C, and D and related time reference x. FIG. 3 is showing a partial section of rotor magnets and stator poles of an internal rotor.

FIG. 4 is showing a partial section of rotor magnets and stator poles of an external rotor.

In FIG. 5 is shown a possible coupling to the rotors output shaft having two plates.

In FIG. 6 is shown a possible vector diagram.

### DETAILED DESCRIPTION OF THE DRAWINGS

FIG. 1 is a schematic of the present inventions AC drive circuit 10 showing components, AC input terminals and the coils two free ends. A first AC input connector 15 is connected to the coils first free end 20. Its second free end 25 in turn is connected to an input terminal 30 of the first switch 35. Switch 35 has an output terminal 40 that has four connections: (1) A diode 45 connected across terminal 30 and 40; (2) a diode 50 connected to the second AC input 55, (3) connected to the output terminal 60 of second switch 65, (4) a signal ground line 41 to pin 4 on sensor 120, ground connection for capacitor 125 and ground connection for transistor 100. The input terminal 70 of second switch 65 is also connected to second AC input 55. A voltage dropping resistor 75 is connected to point 20 and its other end is connected a diode 80 with an output lead connected to pin 1 on sensor 120 and also to a resistor 85 connected to the input end 90 of inverter transistor 100, that also has a base-lead 105 that is connected to a current sense resistor 110 that has connection at point 25. Input end 90 of transistor 100 is also connected to gate lead 115 of the triac 130 that is used as a switch-in device and is also the circuits third electronic switch. Triac 130 has its input lead connected to point 25 and its output connected to second AC input line 55. The sensor's 120 pin 1 has one resistor 135 connected to its pin 2. This pin 2 also has a resistor 140 connected to a gate terminal 145 on the second switch 65. The sensor's 120 pin I also has one resistor 146 connected to sensor pin 3. This pin 3 also has a resistor 150 connected to a gate terminal 155 on the first switch 35. A sensor with one output can also be used,; requiring an inverter transistor to give two outputs (not shown). Point 55 is also the main connection point to second input connection of AC.

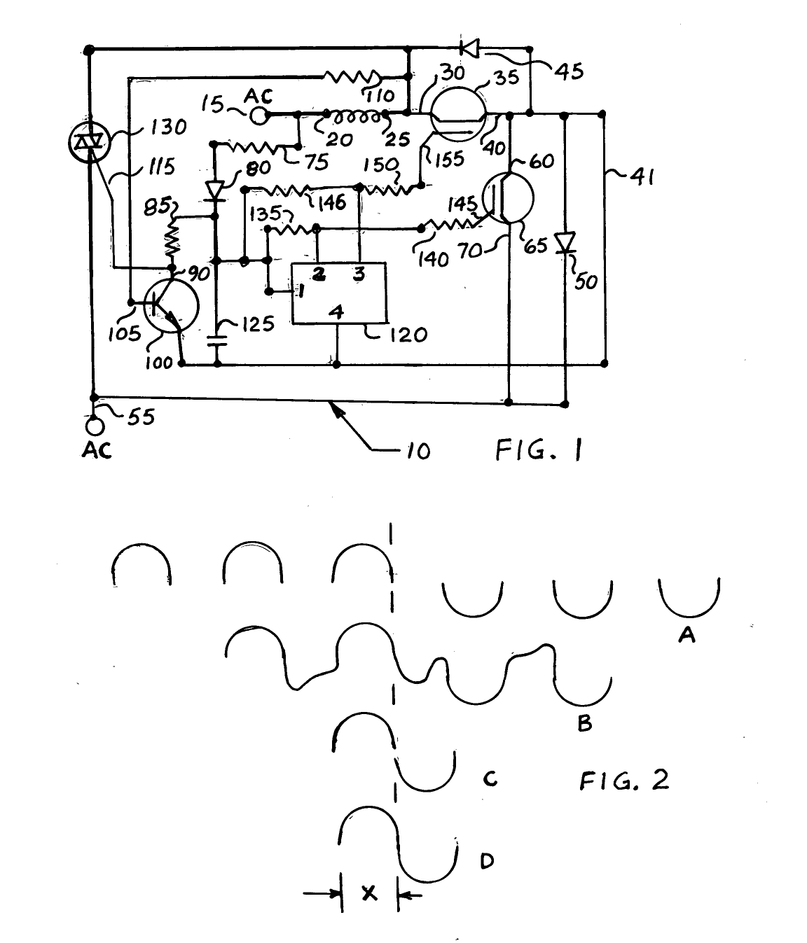

FIG. 2 is showing acceleration sequences A, B, C, and D and related time reference X. “A” is an early acceleration sequence showing three positive and three negative half-phases driving and accelerating the motor up towards speed. During acceleration in “B” back-EMF is also occurring in the winding shown as a distorted wave in B. The amount and wave-shape of the back-EMF depends on inductance and resistance of the coil. At “C” the rotor has reached synchronous speed when one positive and one negative half-phase has become a re-constituted full wave.

Shown in “D” is the smooth AC wave that runs the motor smoothly and uniformly after switch-in of regular AC and the motor is running at synchronous speed. A representative time period (X) is shown at “D”. If the AC driving frequency is 60 hertz this time period would 8.3 milli-seconds.

FIG. 3 is showing a partial section 200 of one version of the present invention. Three rotor magnets marked North, South and North are attached to rotor 210 that has a shaft 220journaled at point 230. A first free end 20 of the stator winding is shown alternately wound on external three stator poles 231, and then continuing 240 to be wound on remaining stator poles and exiting as free end 25 (not shown). A rotor positioning sensor 250 is shown in close relation to the rotor 210 and its magnets FIG. 3 is showing a brushless permanent magnet motor with an internal rotor construction.

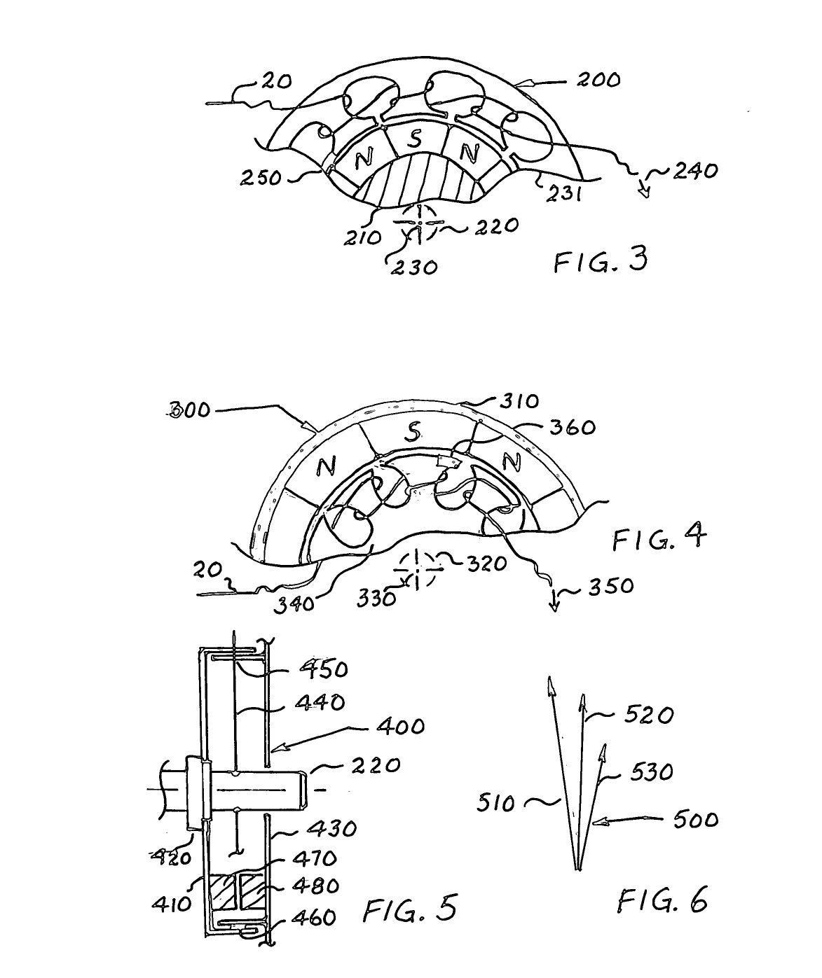

FIG. 4 is showing a partial section 300 of another version of the present invention having three rotor magnets marked North, South and North attached to external rotor drum 310 that has a shaft 320 journaled at point 330. Said rotor drum/magnets 310 is the rotating part. A first free end 20 of the stator winding is shown alternately wound around three internal stator poles 340 and then continuing 350 to be wound on remaining stator poles and exiting as free end 25 (not shown), becoming a brushless motor with external rotor 310. A rotor positioning sensor shown at 360 is shown in close relation to the rotor 310 and its magnets.

In FIG. 5 is shown a possible coupling 400 with one cup-shaped plate 410 attached at 420 to the motors output shaft 220 (or output shaft 320). Co-axially journaled in close relation to plate 410 is a second plate 430. In between plate 410 and 430 is a spring member 440 attached to the output shaft. Said spring member 440 is engaged in slots 450 in plates 410 and 430 to have torsional freedom to rotate within a small angle. Plates 410 and 430 can have a gel 460 atjoint of plate 410 and 430 to dampen torsional vibration. As an alternate structure between the plates 410 and 430 could be mounted one magnet assembly 470 and 480 to in effect make a flexible magnetic coupling.

In FIG. 6 is shown a possible vector diagram 500 that could be representative of one type of winding with line volts 510, line amps 520 and winding phase angle 530.

1. An AC motor drive circuit for a brushless motor comprising:
a rotor with permanent magnet poles journaled in a stator having a like number of poles each comprising alternately wound coils coupled to form a single coil with two free ends,
said two free ends alternately energized with sine wave pulses to start and accelerate said rotor into synchronism with said sine wave, following said synchronism a switch connects said two free ends to AC.

2. An AC motor drive circuit for a brushless motor comprising:
a rotor with a number of alternate polarity permanent magnets,
said rotor having a central shaft rotatably journaled in a stator having a like number of alternately wound coils coupled to form a single coil with two free ends,
said two free ends alternately energized with positive half-phases and negative half-phases of an alternating sine wave,
wherein said energizing produces starting and acceleration-torque for the rotation of said rotor,
following said rotors acceleration into synchronism with said sine wave, a switch connects said two free ends to AC.

3. An AC motor drive circuit for a brushless motor comprising:
a rotor with a number of alternate polarity permanent magnets rotatably journaled in the motor a stator having a like number of alternately wound coils coupled to form a single coil with two free ends,
said two free ends alternately energized with positive half-phases and negative half-phases of an alternating sine wave,
a rotor position sensor sending signals for controlling the timing of said alternate energizing,
said signals connected to two electronic switches and at least two diodes to achieve said alternate energizing that magnetically produces starting and acceleration-torque for the rotation of said rotor,
following said acceleration into synchronism with said sine wave, a switch connects said two free ends to AC.

4. The circuit described in claim 1 wherein said two free ends are the sole electrical connection to said stator.

5. The circuit described in claim 2 wherein said two free ends are the sole electrical connection to said stator.

6. The circuit described in claim 2 wherein said two free ends are alternately energized by two mosfet switches supplying positive half-phases and negative half-phases of an alternating sine wave, thereby alternating the polarity of all said wound coils at one time, producing acceleration of said rotor until the rotor and its central shaft is running in synchronism with said sine wave,
following said synchronism a switch connects said two free ends to AC.

7. The circuit described in claim 6 wherein said switches are selected from one or more of the following:
mosfet, transistor, igbt, scr, or triac.

8. The circuit described in claim 1 wherein said permanent magnet material is selected from:
ferrite, neodymium-iron-boron, alnico, samarium-cobalt.

9. The circuit described in claim 3 wherein said energizing of coils is having 100 percent of coils energized at any one time, and said coils are co-acting with all of said permanent magnets at any one time.

10. The circuit described in claim 3 wherein said two free ends are alternately energized with positive half-phases and negative half-phases of an alternating sine wave, that are re-solved into a re-constituted AC full-wave, driving said rotor in synchronism with said sine wave, and following said synchronization said two free ends are further energized with a household current AC.

11. The circuit described in claim 10 wherein said further energizing is accomplished by an electronic switch switching in said AC and timing said switch-in by the current in said two free ends.

12. The circuit described in claim 11 wherein said switch-in timing is controlled by a micro-controller.

13. The circuit described in claim 11 wherein said switch-in timing controlled by a mechanically operated centrifugal switch or relay.

14. The circuit described in claim 1 wherein said rotor is rotating internally of said stator.

15. The circuit described in claim 1 wherein said rotor is rotating externally of said stator now having external alternately wound coils.

16. The circuit described in claim 3 wherein said rotor position sensor is replaced with a micro-controller that sends said signals for controlling the timing.

17. The circuit described in claim 12 wherein said microcontroller also monitors and corrects both the power input and motor load occurring as current at said two free ends, to optimize efficiency and starting.

18. The circuit described in claim 10 wherein said AC sine wave with its uniform and smooth undulating wave-shape also drives said rotor smoothly, thereby minimizing EMI and rotor torque pulsations.

19. The circuit described in claim 2 wherein said alternate polarity permanent magnets and said wound coils have like number not to exceed twelve pole structures.

20. The circuit described in claim 3 wherein said rotor position sensor is sending said signals through one or more photo-couplers having zero-crossing-switching feature.

21. The circuit described in claim 3 wherein said rotor position sensor is providing locked rotor protection.

22. The circuit described in claim 3 wherein said two free ends are paralleled with an auxiliary winding wherein said auxiliary winding is having from 1 to 45 degree mechanical off-set.

23. The circuit described in claim 3 wherein said rotor position sensor is mechanically off-set from the neutral axis between two of said stator poles.

24. The circuit described in claim 3 wherein said rotor position sensor is replaced by a microcontroller ending said signals for controlling the timing and said energizing, achieving sensor-less operation.

25. The circuit described in claim 2 wherein said motor requires a number of half-phase pulses equal to the number of stator coils to cause the rotor to complete a full revolution.

26. The circuit described in claim 2 wherein said alternating sine wave and its shape can be approximately re-formed from a DC source, in an additional circuit, and said re-formed alternating sine wave having varying frequencies to drive said rotor at varying rotational rates.

27. The circuit described in claim 11 wherein said further energizing is accomplished by a sense resistor and an inverting transistor actuating a triac electronic switch, with said switch-in timing controlled by the current in said two free ends.

28. The circuit described in claim 2 wherein said rotor shaft is having an attached first cup-shaped circular plate, a secondary cup-shaped circular plate co-axially journaled with the first, said secondary plate serving as a torque output plate,
a spring member attached to said shaft engaging slots in both said plates,
giving torsional flexibility between both said plates and said shaft,
and wherein a void between said two plates is filled with a viscous material or gel.

29. The circuit described in claim 28 wherein at least one of said plates is having attached magnets, and said two plates are co-acting through magnetic coupling.
